(19) United States
(12) Patent Application Publication
(10) Pub. No.: US 2014/0328323 A1
(43) Pub. Date: Nov. 6, 2014

(54) Method And System For Single Radio Voice Continuity Handover

(71) Applicants: Lu Zhang, Shenzhen City (CN); Yang Gao, Shenzhen City (CN)

(72) Inventors: Lu Zhang, Shenzhen City (CN); Yang Gao, Shenzhen City (CN)

(73) Assignee: ZTE CORPORATION, Shenzhen, Guangdong (CN)

(21) Appl. No.: 14/358,570

(22) PCT Filed: Aug. 7, 2012
(86) PCT No.: PCT/CN2012/079781

§ 371 Date: May 15, 2014

(30) Foreign Application Priority Data
Nov. 17, 2011 (CN) 201110364959.X

(51) Int. Cl. H04W 36/00; H04L 29/06; H04W 36/12

(52) U.S. Cl. CPC H04W 36/0022; H04W 36/12; H04L 65/103; H04L 69/24
USPC 370/331

(57) ABSTRACT

A method and a system for single radio voice continuity handover. The method includes: performing communication based on a media codec type negotiated by calling and called parties in a process of handing over a voice service from a first network to a second network, wherein the negotiated media codec type is a media codec type supported by a media gateway. With the above technical solution, the problem of frequently transcoding in the prior art is avoided.

### BACKGROUND

1. Technical Field

The present document relates to the field of communications, and in particular, to a method and system for single radio voice continuity handover.

2. Background of the Related Art

An IP Multimedia Subsystem (IMS) is a development direction of future multimedia communication, and is also the most important component of the next generation network. It is a subsystem supporting IP multimedia services proposed by the Third Generation Partnership Project (3GPP). Single Radio Voice Call Continuity (SRVCC) is a function of implementing voice handover between the IMS and the Circuit-Switched (CS) for a radio user in a condition of a single radio. SRVCC corresponds to a UE of the single radio, i.e., the UE can only use one of a radio of 2G/3G and a radio of Long Term Evolution (LTE) at a same moment, and the requirements of the single radio are proposed by a terminal manufacturer, and its purpose is to multiplex the radios and related circuits of the 2G/3G and LTE networks. The particular attributes of the SRVCC due to the single radio are that the handover between the radios is very fast, but before the handover, it needs to establish a CS related channel at a network side and complete an update of a remote end. For the SRVCC handover, in a procedure design, the creation of the CS channel and the remote update are firstly performed, and then the Packet-Switched (PS) to CS handover is performed; and in a roaming condition, time for the remote update is in seconds. During high-speed mobility, the PS related radio (such as LTE radio) of the user attenuates quickly, and possibly before a PS to CS handover instruction is transmitted, the PS related radio has attenuated completely, and it is impossible to complete the handover. In normal conditions, the remote update in seconds will result in a certain media clip, and cause bad user experience (if it is over 200 ms, it can be perceived by the user).

The 3GPP proposes a concept of Enhanced Single Radio Voice Call Continuity (E-SRVCC) to solve the above scheme of reducing handover time: new Access Transfer Control Function (ATCF) and ATGW are introduced to anchor a call to the ATCF, which reduces a handover distance and reduces a signaling transmission time of the remote update. As there is possibility of E-SRVCC handover, if there is no intersection between the codec used by the E-SRVCC user on the audio when a call is established with a remote end in the PS and the codec of the Media GateWay (MGM) through which the call is established finally in the CS, the ATGW needs to perform a corresponding transcoding operation in a process of handover, and even if there is an intersection between the codec supported by the remote user and the codec supported by the MGW at this time, it will generate an unnecessary transcoding process.

### SUMMARY OF THE INVENTION

The embodiments of the present document provide a method and system for single radio voice continuity handover, which avoids the problem of frequently transcoding in the prior art.

In order to solve the above technical problem, the present document uses the following technical solutions.

A method for single radio voice continuity handover, comprising:

performing communication based on a media codec type negotiated by a calling party and a called party in a process of handing over a voice service from a first network to a second network, wherein the negotiated media codec type is a media codec type supported by a media gateway.

The method further comprises: negotiating the media codec type before the process of handing over the voice service from the first network to the second network.

A situation before handing over the voice service from the first network to the second network comprises when creating an original call in the first network.

The step of negotiating the media codec type when creating an original call in the first network comprises:

the calling party transmitting a list of codec types supported by itself to an Access Transfer Control Function (ATCF);

the ATCF adjusting the list of codec types supported by the calling party according to the codec type supported by the media gateway, and forwarding the adjusted list of codec types to the called party; and

the called party selecting at least one codec type from the adjusted list of codec types, and informing the calling party of the selected codec type, wherein the codec type selected by the called party is the media codec type negotiated by the calling party and the called party.

The step of adjusting the list of codec types supported by the calling party according to the codec type supported by the media gateway comprises:

comparing the list of codec types supported by the calling party with the list of codec types supported by the media gateway; and

arranging same codec types in the both lists in the front of the list of codec types supported by the calling party, or in a condition of knowing that the codec types supported by the called party includes the at least one codec type, deleting the codec type not supported by the media gateway from the list of codec types supported by the calling party, leaving only codec types supported by the media gateway.

The method further comprises: negotiating the media codec type during transcoding in the process of handing over the voice service from the first network to the second network.

The step of negotiating the media codec type during transcoding comprises:

the ATCF acquiring the list of codec types supported by the called party;

transmitting the acquired list of codec types supported by the called party to a Mobile Switching Center (MSC); and

the MSC selecting the codec type supported by the media gateway from the list of codec types supported by the called party, wherein the selected codec type is the media codec type negotiated by the calling party and the called party.

The method further comprises: after the negotiation of the media codec type is successful, canceling the transcoding process.

A system for single radio voice continuity handover, comprising a calling party and a called party, wherein,

the calling party and the called party are configured to negotiate a media codec type, and perform communication based on the negotiated media codec type in a process of handing over a voice service from a first network to a second network, wherein the negotiated media codec type is a media codec type supported by a media gateway.

The calling party and the called party are configured to negotiate the media codec type when creating an original call in the first network.

The calling party and the called party are configured to negotiate the media codec type during transcoding in the process of handing over the voice service from the first network to the second network.

The calling party and/or the called party are further configured to cancel the transcoding process after the negotiation of the media codec type is successful.

The embodiments of the present document provide a method and system for single radio voice continuity handover, comprising performing communication based on a media codec type negotiated by a calling party and a called party in a process of handing over a voice service from a first network to a second network, wherein the negotiated media codec type is a media codec type supported by a MGM. In addition to maintaining the function of original high-speed handover of the E-SRVCC, the present application also avoids a process of frequently transcoding, reduces occupation of the transcoding resources in the ATGW, and enhances the utilization efficiency of the ATGW.

### BRIEF DESCRIPTION OF THE DRAWINGS

FIG. 1 is a flowchart of a call establishment phase before single radio voice continuity handover according to an embodiment of the present document;

FIG. 2 is a flowchart of a phase of single radio voice continuity handover according to the embodiment illustrated in FIG. 1; and

FIG. 3 is a flowchart of a method for single radio voice continuity handover according to another embodiment of the present document.

### DETAILED DESCRIPTION

A method for single radio voice continuity handover, comprising: performing communication based on a media codec type negotiated by a calling party and a called party in a process of handing over a voice service from a first network to a second network, wherein the negotiated media codec type is a media codec type supported by an MGW.

The step of negotiating the media codec type by the calling party and the called party may be performed before handing over a voice service from a first network to a second network, or may also be performed during transcoding in the process of handing over a voice service from a first network to a second network.

The present document will be further described in detail below through specific embodiments in combination with accompanying drawings.

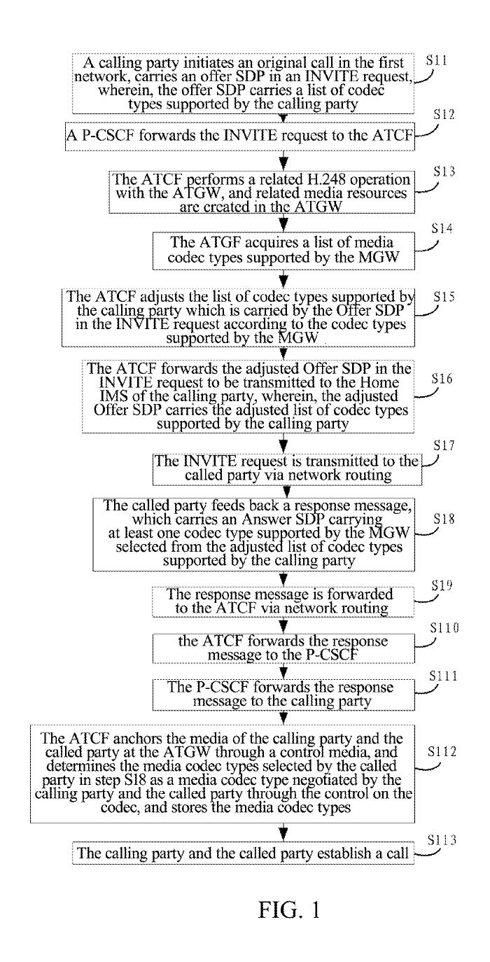

The embodiment will be described by taking negotiation of media codec type when an SRVCC user creates an original call in a first network as an example. FIG. 1 is a flowchart of a call establishment phase before single radio voice continuity handover according to an embodiment of the present document. Please refer to FIG. 1.

In step S11, a calling party (an SRVCC user) initiates an original call in the first network, carries an offer Session Description Protocol (SDP) in an INVITE request, wherein, the offer SDP carries a list of codec types supported by the calling party.

In step S12, a Proxy-Call Control Function (P-CSCF) forwards the INVITE request to the ATCF;

In step S13, the ATCF performs a related H.248 operation with the ATGW, and related media resources are created in the ATGW.

In step S14, the ATGF acquires a list of media codec types supported by the MGW, wherein, the acquisition mode may be interacting with the MGW and acquiring the list from the MGW, or may also be the ATCF configuring locally etc.;

In step S15, the ATCF adjusts the list of codec types supported by the calling party which is carried by the Offer SDP in the INVITE request according to the codec types supported by the MGW.

The mode of adjusting the list of codec types supported by the calling party comprises: comparing the list of codec types supported by the calling party with the list of codec types supported by the MGW; and arranging the same codec types in the both lists in the front of the list of codec types supported by the calling party. The ATCF adjusts the arrangement order of the codec in the list of codec types supported by the calling party, and reasonably guides the calling party and the called party to preferentially select the codec types supported by the MGW when the calling party and the called party perform media negotiation.

In order to avoid the situation that the actually negotiated codec types are codec types not supported by the MGW due to some terminals not preferentially selecting the codec types which are arranged in the front, the codec types not supported by the MGW may be deleted from the list of codec types supported by the calling party in a condition of knowing that the codec types supported by the called party include at least one codec type which is the same in the above both lists, only codec types supported by the MGW are left, i.e., the ATCF only carries the media types which are also supported by the MGW in the list of codec types supported by the calling party in the forwarded Offer SDP, that is, only carrying a codec type which is the same in the above both lists. There are many modes for knowing the codec types supported by the called party, for example, a number segment may be analyzed according to a number of the called party, to know the codec types supported by the called party.

In step S16, the ATCF forwards the adjusted Offer SDP in the INVITE request to be transmitted to the Home IMS of the calling party (a home domain of the calling party), wherein, the adjusted Offer SDP carries the adjusted list of codec types supported by the calling party.

In step S17, the INVITE request is transmitted to the called party (for example, the remote user) via network routing (for example, from the home domain of the calling party to the home domain of the called party, to a visited domain of the called party).

In step S18, the called party feeds back a response message (200 OK or 18x etc.), which carries an Answer SDP carrying at least one codec type supported by the MGW selected from the adjusted list of codec types supported by the calling party.

In step S19, the response message is forwarded to the ATCF via network routing (for example, the Home IMS of the called party, the Home IMS of the calling party).

In step S110, the ATCF forwards the response message to the P-CSCF.

In step S111, the P-CSCF forwards the response message to the calling party.

In step S112, the ATCF anchors the media of the calling party and the called party at the ATGW through a control media, and determines the media codec types selected by the called party in step S18 as a media codec type negotiated by the calling party and the called party through the control on the codec, and stores the media codec types, to facilitate continuously using the media codec type subsequently in the process of handing over the voice service from the first network to the second network.

In step S113, the calling party and the called party establish a call.

In step S18, if there occurs an abnormal condition (if some terminals do not preferentially select the codec types arranged in the front), which results in that the media codec types selected by the called party are not the codec types supported by the MGW, it means that the codec types used by the called party are different from the codec types supported by the MGW, and therefore, related transcoding resources may be previously reserved at the ATGW, and when there occurs an abnormal condition, the ATCF controls the ATGW to start a remedial measure for transcoding.

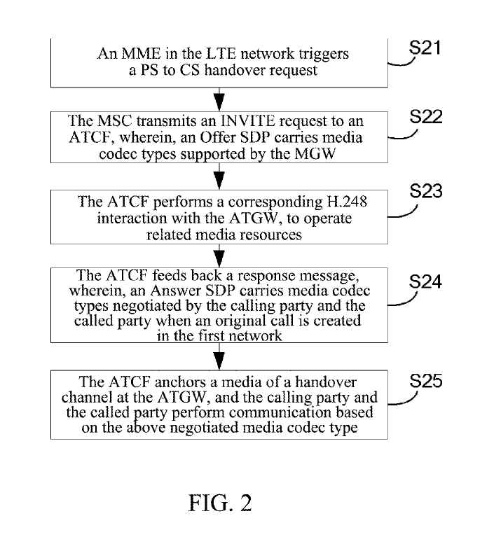

FIG. 2 is a flowchart of a phase of single radio voice continuity handover according to the embodiment illustrated in FIG. 1. Please refer to FIG. 2.

In step S21, a Mobility Management Entity (MME) in the LTE network triggers a PS to CS handover request (for example, the first network is a PS, and the second network is a CS).

In step S22, the MSC transmits an INVITE request to an ATCF, wherein, the INVITE request carries an Offer SDP carrying media codec types supported by the MGW.

In step S23, the ATCF performs a corresponding H.248 interaction with the ATGW, to operate related media resources.

In step S24, the ATCF feeds back a response message, which carries an Answer SDP carrying media codec types negotiated by the calling party and the called party when an original call is created in the first network.

In step S25, the ATCF anchors a media of a handover channel at the ATGW, and the calling party and the called party perform communication based on the above negotiated media codec type, to implement handover of a voice service from the first network to the second network without transcoding by the ATGW.

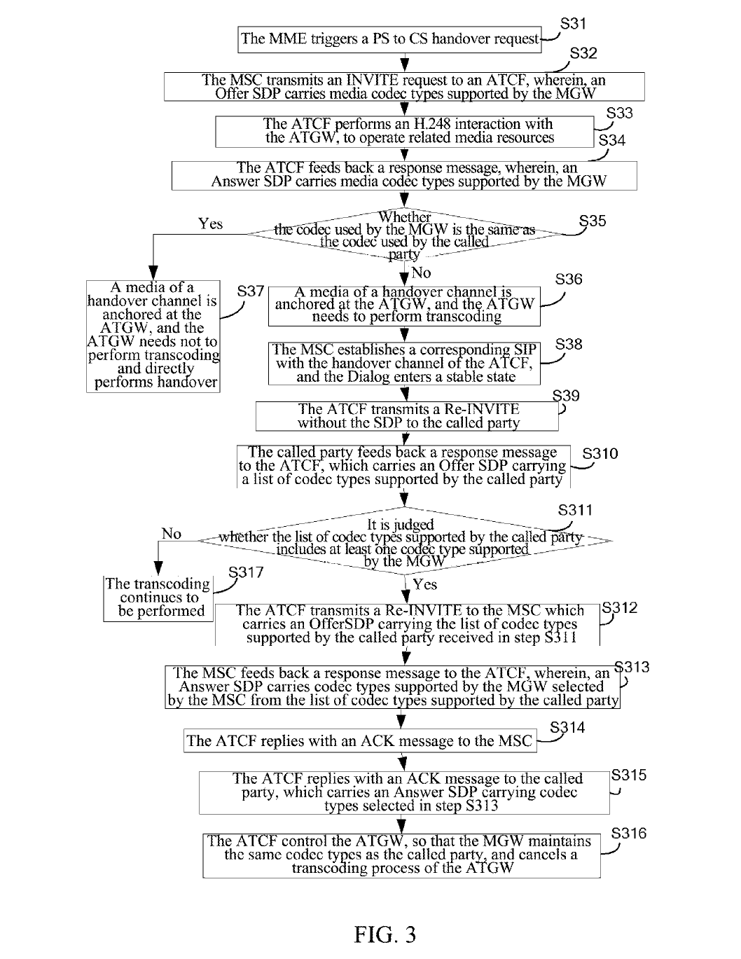

The embodiment will be described by taking negotiation of media codec type during transcoding in a process of handing over a voice service from a first network to a second network as an example. FIG. 3 is a flowchart of a method for single radio voice continuity handover according to another embodiment of the present document. Please refer to FIG. 3.

In step S31, the MME triggers a PS to CS handover request.

In step S32, the MSC transmits an INVITE request to an ATCF, which carries an Offer SDP carrying media codec types supported by the MGW.

In step S33, the ATCF performs a corresponding H.248 interaction with the ATGW, to operate related media resources.

In step S34, the ATCF feeds back a response message which carries an Answer SDP carrying media codec types supported by the MGW.

In step S35, it is determined whether the codec used by the MGW is the same as the codec used by the called party (a remote user), and if not, it is to proceed to step S36, and if so, it is to proceed to step S37.

In step S36, a media of a handover channel is anchored at the ATGW, and as the codec used by the MGW is different from the codec used by the called party, the ATGW needs to perform transcoding and it is to proceed to step S38.

In step S37, a media of a handover channel is anchored at the ATGW, and as the codec used by the MGW is the same as the codec used by the called party, the ATGW needs not to perform transcoding at this time and directly performs handover.

In step S38, the MSC establishes a corresponding Session Initiation Protocol (SIP) with the handover channel of the ATCF, and the Dialog enters a stable state.

In step S39, the ATCF transmits a Re-INVITE without the SDP to the called party to acquire a media capability of the called party.

In step S310, the called party feeds back a response message to the ATCF, which carries an Offer SDP carrying a list of codec types supported by the called party.

In step S311, the ATCF judges whether the list of codec types supported by the called party includes at least one codec type supported by the MGW, and if so, it is to proceed to step S312; otherwise, it is to proceed to step S317.

In step 312, the end-to-end (remote UE-MGW) negotiation is performed again, and the ATCF transmits a Re-INVITE to the MSC which carries an Offer SDP carrying the list of codec types supported by the called party received in step S311.

In step S313, the MSC feeds back a response message to the ATCF, which carries an Answer SDP carrying codec types supported by the MGW selected by the MSC from the list of codec types supported by the called party.

In step S314, the ATCF replies with an ACK message to the MSC.

In step S315, the ATCF replies with an ACK message to the called party, which carries an Answer SDP carrying codec types selected in step S313.

In step S316, the ATCF control the ATGW, so that the MGW maintains the same codec types as the called party, and cancels a transcoding process of the ATGW.

In step S317, in this session, as there is no intersection between the codec used by the MGW and the codec used by the called party, it needs to continuously use the transcoding resources for transcoding.

In the embodiment, during transcoding in a process of handing over a voice service from a first network to a second network, the media codec type is negotiated, and after the negotiation is successful, the transcoding process is cancelled, which reduces the use of transcoding resources.

The embodiments of the present document further provide a system for single radio voice continuity handover, comprising a calling party and a called party, wherein, the calling party and the called party are configured to negotiate a media codec type, and perform communication based on a negotiated media codec type in a process of handing over a voice service from a first network to a second network, wherein the negotiated media codec type is a media codec type supported by an MGW.

Further, the calling party and the called party are configured to negotiate the media codec type when creating an original call in the first network.

Alternatively, the calling party and the called party are configured to negotiate the media codec type during transcoding in the process of handing over the voice service from the first network to the second network.

Further, the calling party and/or the called party are further configured to cancel the transcoding process after the negotiation is successful.

The above contents are further specific descriptions which are made on the present document in conjunction with the specific embodiments; however, the specific implementation of the present document cannot be considered as only being limited to these descriptions. For those of ordinary skill in the technical field to which the present document belongs, on the premise of not departing from the concept of the present document, a number of simple deductions or substitutions can also be made, all of which should be construed as belonging to the protection scope of the present document.

### INDUSTRIAL APPLICABILITY

In addition to maintaining the function of original high-speed handover of the E-SRVCC, the present application also avoids a process of frequently transcoding, reduces occupation of the transcoding resources in the ATGW, and enhances the utilization efficiency of the ATGW.

1. A method for single radio voice continuity handover, comprising:
performing communication based on a media codec type negotiated by a calling party and a called party in a process of handing over a voice service from a first network to a second network, wherein the negotiated media codec type is a media codec type supported by a media gateway.

2. The method according to claim 1, further comprising:
negotiating the media codec type before the process of handing over the voice service from the first network to the second network.

3. The method according to claim 2, wherein, a situation before handing over the voice service from the first network to the second network comprises negotiating the media codec type when creating an original call in the first network.

4. The method according to claim 3, wherein, the step of negotiating the media codec type when creating an original call in the first network comprises:
the calling party transmitting a list of codec types supported by itself to an Access Transfer Control Function (ATCF);
the ATCF adjusting the list of codec types supported by the calling party according to the codec type supported by the media gateway, and forwarding the adjusted list of codec types to the called party; and
the called party selecting at least one codec type from the adjusted list of codec types, and informing the calling party of the selected codec type, wherein the codec type selected by the called party is the media codec type negotiated by the calling party and the called party.

5. The method according to claim 4, wherein, the step of adjusting the list of codec types supported by the calling party according to the codec type supported by the media gateway comprises:
comparing the list of codec types supported by the calling party with the list of codec types supported by the media gateway; and
arranging same codec types in the both lists in the front of the list of codec types supported by the calling party, or in a condition of knowing that the codec types supported by the called party includes the at least one codec type, deleting the codec type not supported by the media gateway from the list of codec types supported by the calling party, leaving only codec types supported by the media gateway.

6. The method according to claim 1, further comprising:
negotiating the media codec type during transcoding in the process of handing over the voice service from the first network to the second network.

7. The method according to claim 6, wherein, the step of negotiating the media codec type during transcoding comprises:
the ATCF acquiring the list of codec types supported by the called party;
transmitting the acquired list of codec types supported by the called party to a Mobile Switching Center (MSC); and
the MSC selecting the codec type supported by the media gateway from the list of codec types supported by the called party, wherein the selected codec type is the media codec type negotiated by the calling party and the called party.

8. The method according to claim 6, further comprising: after the negotiation of the media codec type is successful, canceling the transcoding process.

9. A system for single radio voice continuity handover, comprising a calling party and a called party, wherein,
the calling party and the called party are configured to negotiate a media codec type, and perform communication based on a negotiated media codec type in a process of handing over a voice service from a first network to a second network, wherein the negotiated media codec type is a media codec type supported by a media gateway.

10. The system according to claim 9, wherein, the calling party and the called party are configured to negotiate the media codec type when creating an original call in the first network.

11. The system according to claim 9, wherein, the calling party and the called party are configured to negotiate the media codec type
during transcoding in the process of handing over the voice service from the first network to the second network.

12. The system according to claim 11, wherein, the calling party and/or the called party are further configured to cancel the transcoding process after the negotiation of the media codec type is successful.

13. The method according to claim 7, further comprising: after the negotiation of the media codec type is successful, canceling the transcoding process.
